(19) United States
(12) Patent Application Publication
(10) Pub. No.: US 2002/0123924 A1
(43) Pub. Date: Sep. 5, 2002

(54) Method of gathering local demand data for entertainment performances

(76) Inventor: Benjamin G. Cruz, Baltimore, MD (US)

Correspondence Address: Robert Platt Bell, Registered Patent Attorney, 8033 Washington Road, Alexandria, VA, 22308, US

(21) Appl. No.: 10/086,733

(22) Filed: Mar. 4, 2002

Related U.S. Application Data
(60) Provisional application No. 60/272,764, filed on Mar. 5, 2001.

(51) Int. Cl. G06F 17/60

(52) U.S. Cl. 705/10

(57) ABSTRACT

Indications of consumer demand for local presentation of entertainment performances in geographic areas are gathered via the Internet. Contact information, consumer preferences, and demographic information may also be collected from consumers. The information may be stored in a database or databases. The demand information is made available to individuals and companies which produce, promote, distribute, sell and host shows as well as the performers and their representatives. Demographic. lifestyle, and voter preference information, coupled with voter entertainment demand, geographic location, and contact information, may be used by the database owner, on behalf of third parties, to provide promotional and advertising messages to voters, to provide product and service offers to voters, and to conduct custom research studies. Demographic, lifestyle, and voter preference information, coupled with voter entertainment demand, and geographic location is provided, in aggregate, to consumer products, consumer services, and advertising companies as a tool to assist in formulating advertising and marketing strategies.

### CROSS-REFERENCE TO RELATED APPLICATIONS

The present application claims priority from Provisional U.S. Patent Application No. 60/272,764 filed on Mar. 5, 2001, and incorporated herein by reference.

### FIELD OF THE INVENTION

The present invention generally relates to presenting and marketing entertainment-related information, and more specifically, using such information to optimize event attendance and sales of related merchandise and services. In particular, the present invention generally relates to providing location-sensitive demand measurement to facilitate decision making regarding the presentation of entertainment (shows), optimizing audience attendance and sales of related merchandise and services, reducing expenses of promoting shows, and uncovering changes in the popularity of entertainers, locally and globally.

### BACKGROUND OF THE INVENTION

The marketplace for entertainment performances (live, filmed, and broadcast) is inefficient, due in large part to the nature of entertainment performances as a service. While it is possible to forecast with some accuracy the demand for many consumer goods and services based on past consumption and other variables, the same may not sufficiently accurate with respect to entertainment, particularly with respect to a show which has never before been performed in a given locale.

A show exists for a brief period in time and subsequently is no longer available for consumption. As such, it must be purchased and consumed when temporarily available. If not sold, a live performance cannot be resold to a secondary, discount market. A film showing or performance broadcast may be resold in the co-called secondary market (i.e., video or DVD release, cable TV, re-runs, and the like). However, these secondary markets may generate less revenue per customer than the original film showing or performance broadcast.

Entertainment performances are presently scheduled to take place in a given city and a particular venue without sufficient knowledge of the level of demand which exists in that locality. As a result, many performances suffer from audiences which are small relative to the size of the venue and relative to the anticipated attendance. Many shows are, therefore, staged at an economic loss to one or more of the participants in the value chain. In other instances, demand far outstrips available supply (number of seats in a given venue) resulting in lost revenue opportunity to the performer.

Entertainment performance contracts are put together in a variety of ways amongst participants and companies which produce, promote, sell, and host shows as well as the performers and their representatives (collectively, the “value chain”). One or more of the participants in the value chain takes a risk on the performance. If it is not well-attended, those participants may lose money on the performance. The risk-taker(s) need(s) a way to better gauge the likelihood of attracting sufficient attendance.

Often the risk-taker(s) is (are) responsible for marketing-attracting an optimum attendance. Sometimes this responsibility for marketing a live performance falls to a professional promoter. Money is spent on a combination of advertising, public relations, and other marketing tactics specific to the entertainment market. The more effectively the available monies are spent, the greater likelihood the event will be profitable for the risk-taker. Cost-effective methods to promote the show, such as getting radio stations to play the works of musical artists or performers scheduled to appear locally, are usually very resource-intensive activities.

Consumers have no direct means of attracting a particular show to their locality. Currently, consumers must passively await the scheduling of a desired performance in their vicinity and hope to learn of it sufficiently in advance of the performance to be able to acquire tickets. Show producers and promoters do not know which specific individuals in a locality have a desire to see the show they have scheduled for a performance. Therefore, they must use expensive mass-advertising methods to attract an audience for the show.

Existing measurement services for entertainment include services by Edison Media Research (ConcertPoll-concert audience profiling) ; Arbitron (air play of music via broadcast radio) ; Measurecast (digital, streaming of music via the Internet); Soundscan (retail sales of recorded entertainment) ; A. C. Nielsen (television audience viewing). Other similar services exist to quantify consumption of recorded entertainment or live entertainment post-consumption or post-purchase.

Several music-related web sites conduct polls of site visitors with the question “Who is your favorite artist?”. A few web sites related to motion pictures poll site visitors regarding their favorite film. These and other measurement services do not provide any tangible benefit to the voter or survey participant beyond the possibility to learn about aggregate preferences of participants.

Therefore, there exists a need in the Art for a technique for providing location-sensitive demand measurement to facilitate cost-effective decision making in scheduling and promoting events.

There furthermore exists a need in the Art for a technique for utilizing demographic data from such demand measurement to target market specific related or non-related products.

### SUMMARY OF THE INVENTION

The present invention provides a technique to measure demand for shows which have yet to be presented, with sufficient location sensitivity to be used to estimate attendance at a possible, eventual presentation. This technique provides voters the possibility to influence the decision to present a specific show in the voter's locality. When a show is scheduled, the invention also provides a means to contact interested consumers that the show is scheduled.

In the present invention, a means of alleviating or reducing the impact of the foregoing problems is to collect expressions of consumer demand, locality by locality in the form of a consumer voting mechanism focused at entertainment performances. The present invention provides a way to vote for shows to be performed in any locale and to use the resulting data for market and industry research, promotion, and sales of related or unrelated services and merchandise. Therefore, the present invention measures demand for shows that have yet to be presented, with sufficient location sensitivity to be used to estimate attendance at a possible, eventual presentation. As such, the invention also provides voters the possibility to influence the decision to present a specific show in the voter's locality.

Using the resulting demand data, participants in the value chain may determine with increased certainty which locales will produce optimum size audiences for various, specific performances. Knowing which consumers have voted to see a given show makes it possible to maximize attendance at low advertising and promotion cost by alerting those same consumers once a performance of that particular show has been scheduled in their vicinity. Along with notification, tickets and show-related or artist-related merchandise and services may be sold to the recipients of the alerts.

The present invention also may be used to track changes in popularity of entertainers and the like (as well as entertainment genres) both locally and globally. For example, the popularity of stand-up comedy may be increasing in the Northwest region of the country while the demand for live jazz performances is declining. Or, as another example, a particular little-known local performer may be recently gaining in popularity regionally or nationally as evidenced by significant growth in demand for live performances outside his local area.

The voting mechanism of the present invention may be activated, for example, by links on popular third party web sites and other interactive media platforms such as interactive kiosks situated at any physical location, notably where entertainment is experienced or purchased. When activated, the voting form provides fields in which the voter may furnish the required information.

The present invention may also be used to promote sales of event or performer-related goods and/or services. For example, in the case of musical performances, the sale of recorded music and fan merchandise of the artist or performer may be elevated on the dates following attendance at the show. Messages may be sent, using the present invention, to the voter, offering easy and/or discounted purchase of merchandise.

Graphical or textual links, placed in proximity to information on shows, artists, media clips and other entertainment-related content, may provide contextual relevance which stimulates the use of the voting mechanism. Voting forms may also be actuated by hyperlinks embedded in digital media players, including but not limited to RealPlayer (by RealNetworks, Inc.) or Windows Media Player (by Microsoft, Inc.).

Such hyperlinks may allow consumers to vote while experiencing digital media presentations of artists or performers and shows formatted for playback by those media players or at internet sites, interactive CD-ROMS, DVDs, or the like. The emergence of interactive television systems provides another possible avenue for voters to register their desire to see specific live performances. Interactive, touch-tone telephone response systems and the emergence of interactive voice response systems, supported by speech recognition technologies provide means for voting through the use of any telephone.

It is therefore one object of the present invention to provide a way to vote for shows to be performed in any locale and to use the resulting data for market and industry research, promotion and sales of related services and merchandise.

According to the invention, there is provided a method for collecting votes for shows, voter demographic and personal information, storing the data in a database and making certain of these data elements accessible to customers, particularly companies in the entertainment and advertising industries. There is also provided a method for sending show alerts and merchandise and ticket offers to voters via electronic messaging.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a block diagram illustrating the creation and use of the voting form and databases.

FIG. 2 is a block diagram illustrating the use of the database and interactive media to provide data elements to customers and voters according to the invention.

FIG. 3 is a block diagram illustrating how advertisers may communicate marketing messages or sales offers to voters based on specific consumer characteristics.

FIG. 4 is a block diagram illustrating how various products and services companies or institutions may request the database owner to conduct custom research studies which target voters based on specific characteristics as well as entertainment preferences and purchase history.

### DETAILED DESCRIPTION OF THE INVENTION

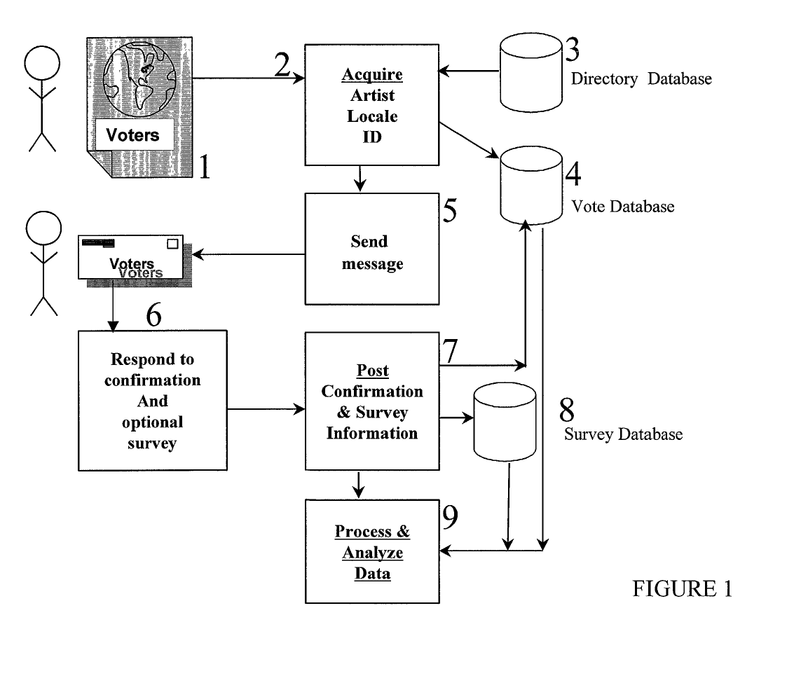

FIG. 1 is a block diagram illustrating the creation and use of the voting form and databases. In FIG. 1, a vote is created for an entertainment performance (or “show”) to be presented in the consumer's (the “voter's”) locality and further demographic and preference information is collected from the voter. When visiting sites on the internet or other electronic media platforms, the voter may indicate a desire to see a particular show.

Voter 1 may actuate a graphical or text hyperlink to launch a voting form 2 connected to Vote Database 4 for the collection of votes. This graphical or text hyperlink, for example, may appear as a voting button or other link on a number of 3rd party websites which may or may not be music or performance related. Thus, a plurality of different websites targeting different types of audience segments may be used to obtain a broad base of potential voters. Voter 1 need not visit a specific voting website to participate, although a dedicated voting website may be provided as an alternative embodiment or in conjunction with voting buttons or links provided on 3rd party websites.

If the desired artist or performer or show name is not found in Directory Database 3, the voter manually enters the name of the show or artist or performer the voter wishes to see and information to identify the voter such as a user name (which may be the voter's e-mail address) and a password, if desired by the database owner, for security purposes. Also entered is the metropolitan area, or other geographical reference such as a zip code, regarding where the voter would like to see the show—usually the voter's general locality.

Information gathered by the voting form may be stored in Vote Database 4. Preferably, A confirming e-mail or other communication may be sent to the voter(s). In one embodiment, the voter may be able to validate 7 the vote which was cast by responding to the e-mail. The e-mail message may also ask the voter to go to the database owner's (or other) web site to provide 6 additional demographic data, preference data and personal data. Personal data (e.g., name, address, and other specific data) may be provided at each voter's option and may not be required in order for a voter to participate.

The voters may also indicate what price they may be willing to pay to see the show for which they voted. Each voter is also asked to indicate their approval for other parties to contact them using the e-mail address provided. Data provided by voters in this step may be stored in the Survey Database 8.

The data collected may be regularly inspected to ensure data integrity and to eliminate instances of duplicate votes for a particular show cast by the same voter. The data may then be analyzed 9 on a regular schedule using standard statistical techniques to provide reports useful to entertainment consumers, the entertainment industry, and the advertising industry and other interested parties. This data may be sold or rented in the form of a database or as data reports or the like.

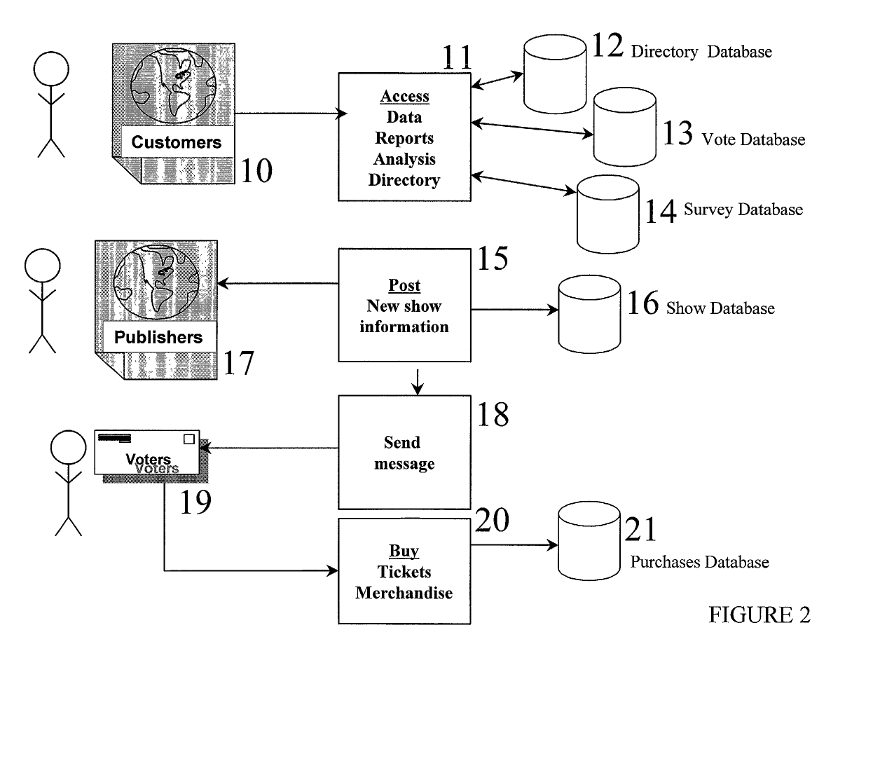

Referring now to FIG. 2, using electronic (or other) media such as the Internet, customers 10 from the entertainment industries and the advertising industry (or other interested parties) may access 11 raw data or reports from one or a combination of Directory Database 12, Vote Database 13 and Survey Database 14. Using the information, customers may, for example, uncover demand in various localities for specific artists or shows.

If demand is sufficient to produce and promote a show in a specific geographic area, artists, venues, promoters and their representatives may enter their contact information in Directory Database 12 to allow others in the “evalue chain” to contact them. They may also search 11 for contact information for others in the value chain. With the help of the directory service, the members of the value chain may collaborate to produce shows in locales where demand is sufficient to meet their profit objectives or other objectives (promotion, artist exposure, and the like). Members of the value chain 10 may also uncover increasing demand for shows to discover rising talents who may be in need of representation by talent agents, promoters, artist managers, record labels, and the like.

Artists 10 may retrieve contact information, from the Vote Database 13 and/or Survey Database 14, regarding those consumers who voted for that artist and, additionally, have agreed that the artist may contact them. This contact information may be used by the artist for direct marketing and promotion (e.g., inclusion in the artists fan club and mailing list).

When a show is scheduled, the details of the show may be entered 15 into Show Database 16 so that an e-mail message 18 may be sent to voters 19 allowing them to plan to attend the show and to purchase tickets 20 to the show, using electronic commerce services, if available. In the days surrounding the show, the voter may be alerted 18 to special sales of merchandise or services related to the show or the artist. Such merchandise and services may be available for purchase 20 either on-line or through other channels.

Information regarding demand for shows or artists may be licensed to companies in various media for publication 17 electronically or through traditional means. Information in such reports may include rankings of the top 25 performers in terms of audience demand growth. Thus, reports similar to Arbitron or Nielsen reports may be generated and distributed to a base of subscribers based upon the data collected. However, unlike Arbitron or Nielsen reports, which disclose actual audience, the present invention provides data which predicts future audience participation.

Information regarding shows which have been scheduled may also be licensed to companies in various media for publication 17 electronically or through traditional means. Information in such reports may include concert and entertainment calendars and scheduling services.

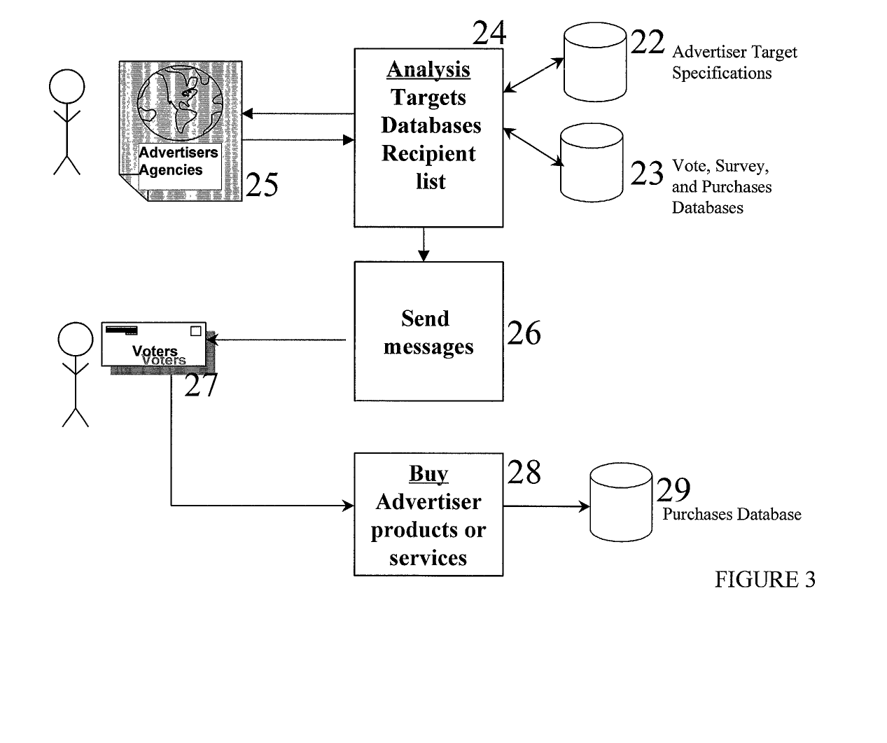

Referring now to FIG. 3, advertisers 25 for various products and services may wish to communicate marketing messages or sales offers to voters based on specific consumer characteristics including demographic, geographic, and lifestyle preference factors as well as entertainment preferences and purchase history.

Advertiser 25 may provide specifications 22 for consumer targeting in consultation with the database owner or operator. The database owner or operator may perform analysis 24 of relevant databases 23 to identify the specific voters matching the advertiser's specifications. Databases 23 may comprise at least portions of one or more of databases 12, 13, 15, 16, and 21 of FIG. 2. Advertiser 25 may then approve a recipient list and provide marketing message 26.

Marketing message 26 may be sent to a list of identified voters 27 to promote purchase of the advertiser's goods or services 28. If agreed by advertiser 25, certain purchase information may be added to the voters purchase history database 29, which may be augment the data available in database 21 of FIG. 2.

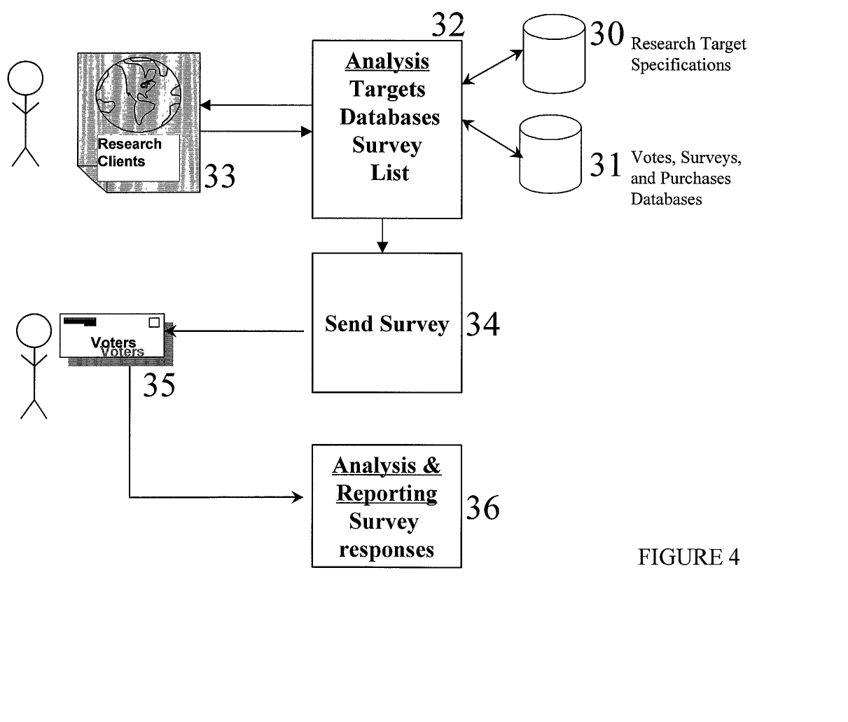

Referring now to FIG. 4, various products and services companies or institutions may request the database owner or operator to conduct custom research studies which target voters based on specific characteristics including demographic, geographic, and lifestyle preference factors as well as entertainment preferences and purchase history.

The research client 33 may provide research target specifications 30 for targeting the research study. The database owner or operator may perform analysis 32 of relevant databases 31 to identify the list of voters comprising the optimal survey panel. Databases 31 may comprise at least portions of one or more of databases 12, 13, 15, 16, and 21 of FIG. 2 and databases 22 and 29 of FIG. 3. Research client 33 may approve the survey panel and provide the research study instrument 34 which may be sent by the database owner or operator to a list of approved voters 35. Surveys may be returned to the database owner or operator for analysis and/or reporting of response data 36 to the research client 33.

The present invention offers a number of benefits. The benefit for the voter is the ability to influence the decision by the value chain to produce a show in the voter's geographic area. Also the voter receives the benefit of the possibility of receiving attractive offers related to the show or artist for which the vote was cast.

The benefits to artists include uncovering demand for their performances in various geographic markets and the ability to use demand data as a marketing tool in efforts to interest record producers in signing recording contracts. The artists also benefit from the ability to increase the number of fan club members on their mailing lists for one-to-one marketing, including sales of recordings of the artists' works and promotional merchandise.

The benefits to other participants in the entertainment value chain include the ability to better target localities in which to present performances, improving the chances of successful and profitable shows. Venues of appropriate capacity may be selected based on anticipated attendance and multiple presentations of the same show may be scheduled as demand warrants. The costs to promoters of attracting an audience are reduced since those consumers who indicated a desire to see the show are alerted directly rather than through high cost, mass media advertising. For venue owners, use of demand data may ease the process of choosing from among available performances to present on a given date.

Record producers may use the data or trend analysis to discover promising talent from among thousands of musical artists who do not yet have contracts with record labels. They may also use the data to analyze the cost versus benefits of providing financial support for one of their signed artists to undertake a regional, national or international performance tour.

Record distributors and retailers may use demand data to help them to decide on inventory levels for the recordings of artists, particularly in the days and weeks surrounding a scheduled performance.

Radio stations may use local demand for live performances by musical artists to assist with programming decisions. Local entertainment event calendars are in high demand on radio station web sites according to a recent study by Arbitron.

Interactive media companies, particularly those using the Internet, may use information regarding the most in-demand shows to enhance their content. Studies show that consumers like to be aware of what other consumers' preferences are and that information of this kind attracts and retains readers/subscribers/users. Non-interactive media companies and outlets (e.g., traditional newspapers and the like) may also use the information gathered by the present invention as a data source.

Advertising agencies may use the demand, demographic and personal preference data, in aggregate form, to formulate advertising campaigns targeted at a highly sought-after group of consumers on behalf of clients who produce lifestyle products and services. Advertisers also benefit from the ability to send promotional and advertising messages to voters likely to be interested in the advertisers' products and services based on finely targeted consumer profiles.

Research clients benefit from the ability to conduct surveys of consumers of entertainment performances targeting research panels selected on the basis of finely targeted consumer profiles.

While the preferred embodiment and various alternative embodiments of the invention have been disclosed and described in detail herein, it may be apparent to those skilled in the art that various changes in form and detail may be made therein without departing from the spirit and scope thereof.

For example, the term “live performances” as used in the present invention may refer to rock concerts, classical concerts, jazz concerts, music festivals, dance raves, or the like, as well as plays, musicals, broadway shows, performance art, circuses, trade shows, monster truck rallies, RV and Boat shows and the like, or other live action attractions.

In addition, as used in the present invention, the term “artist” or “performer” can be construed to include performing groups, individuals, lecturers, stand-up comedians, or the like. Lecturers, celebrity appearances, and other types of shows, entertainments, and presentations may also fall within the scope of the present invention.

In addition to allowing consumers to “vote” on particular performers, the present invention may also be used to allow consumers to vote on program content. Thus, for example, consumers may “vote” on upcoming symphony or opera programs, for example, or even on which songs they wish to hear at a particular concert.

However, the present invention need not be limited to such live attraction events. Other applications (as previously noted) include movies and broadcast entertainment. Movies may include first run films, as well as revivals, “art” films, foreign films independent films, and the like. Particularly for smaller “independent”, foreign or “art” films, gauging potential audience may be particularly critical, as the number of movie “art” houses in the United States has steadily decreased due to loss of viewers and competition from other sources (e.g., video, DVD, cable and satellite television). For operators of such limited audience venues, it may be particularly essential to be able to gauge audience participation before ordering a film.

For non-live events, the present invention operates in a similar manner as described above in connection with live performances, with the exception that there may not be an artist, performer, or performing group per se.

For first-run films, the present invention may be used to gauge consumer interest such that a theater operator or film distributor may accurately gauge how long a film should be played as a “first run” event before releasing to the secondary markets (e.g., pay-per-view, cable, overseas, DVD, video). Consumer interest may be such that a distributor may decide to “revive” a first run film for further showing before releasing on the secondary market. As noted previously, the income received per consumer for a first-run film is usually higher than in the secondary market.

Thus, if demand for a film remains high, it might make more sense to the distributor to re-release the film for additional showings before allowing the film to appear in the secondary markets. The present invention provides a way of gauging such consumer interest and correctly timing the release and duration of release of a film. Prior to the present invention, such decisions were made with little, if any hard data, and based more on intuition and experience than on scientific data gathering.

In addition, the present invention may be used to allow consumers to “vote” on other non-live attractions, such as art exhibits, museum exhibits, and the like. An art gallery or museum may gauge in advance what audience response will be like to a particular exhibit before staging such an exhibit for the public. Consumers have a means of influencing which exhibits are staged in advance of or during the planning process.

In addition, the present invention may even be used to gauge demand for broadcast performances (including live performances, as well as films and video). Broadcast executives have many data sources (e.g., Nielsen and the like) to measure actual usage of broadcast material. However, few methods are available to predict demand. Before scheduling a major live televised broadcast or internet presentation of a major live recorded concert, or televised release of a movie, the present invention may be used to gauge demand for such programming material, nationwide, world wide, or even with a particular market.

The present invention may be applied in such a manner to network television, public television, cable and satellite television, including regular and premium channels, as well as pay-per-view channels. The present invention may be used for special televised events, such as live performances or movie showings, as well as for more mundane fare such as television sit-coms, re-runs, and the like. In addition, the present invention may be applied to internet (e.g., video data streaming) presentations.

For re-runs or the syndication market, a local television station may be able to use the present invention to gauge consumer interest in a particular television series and even particular episodes of a television series. Viewers may have specific preferences, and following these preferences may insure the highest possible ratings for a given particular time slot.

It should also be noted that predictions of show attendance from consumer votes can be adjusted and expanded based upon actual performance attendance history. For example, it may be anticipated that not all audience members may vote on a particular performance, as many may not access the internet or may decline to participate in the voting scheme. However, actual received votes can be projected as a sample of a wider audience. Actual attendance figures may be used to fine tune such projections (higher or lower) and may even be adjusted based upon geographical area, musical genre or the like, or statistical error.

Thus, actual attendance, viewership or audience figures can be compared to pre-show voting and the value of pre-show votes as an indicator of consumer demand determined. This valuation may be applied to future votes to even more accurately predict attendance.

In addition, although disclosed in the primary embodiment as configured in a web site, kiosk, e-mail message or the like, the present invention may also be applied to other forms of communication, including, but not limited to, interactive wireless devices such as Blackberry, PDAs, cellular phones (e.g., Gen 3 cellular), interactive DVDs, CD-ROMs, interactive television devices (e.g., Wink TV, cable and satellite television consumer purchase and feedback devices) and the like.

In addition, although optional consumer messages are disclosed in the primary embodiment as being sent by confirming e-mails and the like, other forms of communication, including voice-mail messages, digital messages via cell phone or PDA or the like, or other means of communication (including even regular mail) may be used without departing from the spirit and scope of the present invention.

We claim:

1. A method of collecting expressions of consumer demand for performances and making the data available to customers to support decisions regarding performances, said method comprising the steps of:
receiving data from consumers including votes indicating consumer demand for a performance,
housing collected data in a database, and
providing of non-personal consumer data from the database to customers to support decisions to present entertainment performances.

2. The method of claim 1, wherein said step of receiving data from consumers further comprises the step of:
receiving data from consumers indicating consumer demand for a consumer desired general locale for the performance.

3. The method of claim 2, wherein said step of providing of non-personal consumer data from the database to customers to support decisions to present entertainment performances includes the step of providing consumer demand data for a consumer desired general locale for the performance so as to support customer decisions to present entertainment performances at optimal locales.

4. The method of claim 3, wherein said step of providing of non-personal consumer data from the database to customers to support decisions to present entertainment performances includes the step of analyzing and sorting consumer data and formatting analyzed and sorted consumer data for reporting.

5. The method of claim 1, wherein said step of receiving data from consumers further comprises the step of:
receiving consumer contact data from consumers.

6. The method of claim 1, further comprising the step of:
receiving data from consumers from supplementary survey forms to provide demographic, contact, opinion and personal preference data.

7. The method of claim 1, further comprising the steps of:
storing, in the database, details of entertainment events which have been scheduled, and
sending messages to consumers that a requested performance has been scheduled.

8. The method of claim 7, further comprising the steps of:
receiving, from an advertiser, specifications for consumer targeting,
analyzing the database to identify the specific consumers matching the advertiser specifications, and
sending marketing messages to the specific consumers.

9. The method of claim 7, further comprising the step of:
sending messages to consumers offering at least one of goods and services associated with at least one of the performance, the performer(s), and parties to which the consumer has agreed to be solicited from.

10. The method of claim 9, further comprising the step of:
sending consumer contact information to performers, if permitted by consent of consumer.

11. The method of claim 7, further comprising the step of:
providing consumer demand, demographic and preference data, in aggregate form, to customers for market analysis.

12. The method of claim 7, further comprising the step of:
using contact information, geographic, demographic and preference data to formulate targeted survey panels for the conducting of custom research projects on behalf of third parties.

13. The method recited in claim 1 wherein consumer data is received over a network, the step of receiving consumer data further comprising the step of:
voting, by a consumer using a voting form presented to the consumer by activation of at least one of a hyperlink and menu selection incorporated into at least one of a web site and an web-based media player.

14. The method recited in claim 13 wherein the voting is conducted via digital media devices connected to wireless networks.

15. The method recited in claim 13 wherein the voting is conducted via any voice-enabled information input and access device.

16. A system for collecting expressions of consumer demand for performances and making the data available to customers to support performance decisions, said system comprising:
means for receiving data from consumers including votes indicating consumer demand for a performance;
a database for housing collected data; and
means for providing of non-personal consumer data from the database to customers to support decisions to present entertainment performances.

17. The system of claim 16, wherein said means for receiving data from consumers further comprises:
means for receiving data from consumers indicating consumer demand for a consumer desired general locale for the performance.

18. The system of claim 17, wherein said means for providing of non-personal consumer data from the database to customers to support decisions to present entertainment performances includes means for providing consumer demand data for a consumer desired general locale for the performance so as to support customer decisions to present entertainment performances at optimal locales.

19. The method of claim 18, wherein said means for providing of non-personal consumer data from the database to customers to support decisions to present entertainment performances includes means for analyzing and sorting consumer data and formatting analyzed and sorted consumer data for reporting.

20. The system of claim 16, wherein said means for receiving data from consumers further comprises:
means for receiving consumer contact data from consumers.

21. The system of claim 16, further comprising:
means for receiving data from consumers from supplementary survey forms to provide demographic, contact, opinion and personal preference data.

22. The system of claim 16, further comprising:
means for storing, in the database, details of entertainment events which have been scheduled; and
means for sending messages to consumers that a requested performance has been scheduled.

23. The system of claim 22, further comprising:
means for receiving, from an advertiser, specifications for consumer targeting;
means for analyzing the database to identify the specific consumers matching the advertiser specifications; and
means for sending marketing messages to the specific consumers.

24. The system of claim 22, further comprising:
means for sending messages to consumers offering at least one of goods and services associated with at least one of the performance, the performer(s), and parties to which the consumer has agreed to be solicited from.

25. The system of claim 24, further comprising:
means for sending consumer contact information to performers, if permitted by consent of consumer.

26. The system of claim 22, further comprising:
means for providing consumer demand, demographic and preference data, in aggregate form, to customers for market analysis.

27. The system of claim 22, further comprising:
means for using contact information, geographic, demographic and preference data to formulate targeted survey panels for the conducting of custom research projects on behalf of third parties.

28. The system recited in claim 16 wherein consumer data is received over a network, the means for receiving consumer data further comprising:
means for voting, by a consumer using a voting form presented to the consumer by activation of at least one of a hyperlink and menu selection incorporated on at least one of a web site and an electronic, web-based media player.

29. The system recited in claim 28 wherein the voting is conducted via digital media devices connected to wireless networks.

30. The system recited in claim 28 wherein the voting is conducted via any voice-enabled information input and access device.
